(19) United States
(12) Patent Application Publication
(10) Pub. No.: US 2005/0196545 A1
(43) Pub. Date: Sep. 8, 2005

(54) Method for producing a composite layer

(75) Inventor: Hiroaki Ando, Tokyo (JP)

Correspondence Address: MUSERLIAN, LUCAS AND MERCANTI, LLP, 475 PARK AVENUE SOUTH, 15TH FLOOR, NEW YORK, NY, 10016, US

(73) Assignee: Konica Minolta Holdings, Inc.

(21) Appl. No.: 11/063,929

(22) Filed: Feb. 23, 2005

(30) Foreign Application Priority Data
Mar. 3, 2004 (JP) JP2004-058644

(51) Int. Cl. B05D 1/02

(52) U.S. Cl. 427/446

(57) ABSTRACT

Disclosed is a method for forming a composite layer, in which a mixture of the inorganic particles and the thermoplastic resin are flame sprayed to a substrate at a temperature of not less than the glass transition point of the thermoplastic resin and not more than melting point of the inorganic particles, wherein the mixture comprises 85-99% by weight of the inorganic particles and 15-1% by weight of the thermoplastic resin, total weight of the mixture being 100% by weight.

### FIELD OF THE INVENTION

The present invention relates to a producing method of a composite layer by flame spraying a mixture of inorganic substance and an organic substance, and a composite panel which can be utilized for a radiation image conversion panel by using a phosphor as the inorganic substance.

### RELATED ART

A flame spraying method is widely applied for treating the surface of various members. The substrate to be flame sprayed includes many materials such as wood, ceramics, cement and metal. The object and use of the treatment is expanded to giving abrasion-resistant ability, anti-corrosion ability and heat insulating ability, surface property improving and thickening.

Various composite layers can easily formed by the flame spraying method, for example, a composite layer of ceramics and metal and that of resin and inorganic element have been known. For example, a particle of a mixture of nylon and epoxy resin for flame spraying is proposed, cf. Patent Document 1. A method for forming an ablatable layer by flame spraying particles composed of aluminum and polyester resin is disclosed, cf. Patent Document 2. Moreover, a method is concretely disclosed, in which flame spraying is performed at a low temperature so that the resin particles are only melted and the inorganic resin particles are not melted, cf. Patent Document 3.

The methods described in the above patent documents are proposed for producing the layers superior in the anti-corrosion and ant-abrasion abilities. However, the layers have a high content of resin and a low content of inorganic element. Consequently, sufficient properties cannot be obtained some times for a specific use. In concrete, in a composite layer utilizing the optical property of an inorganic particle, light is easily scattered in the layer when the resin content in the layer is high since the difference of refraction index of the resin and that of the inorganic material is usually large. Moreover, the resin itself absorbs the light in some cases so that the property of the inorganic particle is difficultly displayed.

On the other hand, a method for directly outputting an image from a phosphor layer composed of inorganic particles by employing a composite layer utilizing the optical property of the inorganic particle. In such the method, radiation permeated trough an object is absorbed by a stimulable phosphor and then the radiation energy absorbed and accumulated by the phosphor is emitted by stimulating by light or thermal energy and the emitted light is detected for imaging.

In concrete, for example, the radiation image conversion methods employing the phosphors described in U.S. Pat. No. 3,859,527 and JP-A No. 55-12144 have been known.

In this method, a radiation image conversion panel is employed; radiation permeated through an object is irradiated to the phosphor layer of the radiation image conversion panel so that the radiation energy corresponding to the permeation density of each part of the object is accumulated in the phosphor layer, and then the radiation energy is emitted as stimulating light emission by time serially stimulating the phosphor layer by electromagnetic wave such as visible rays or infrared rays. Thus obtained signals according to the intensity variation of the emitted light is converted to, for example, electrical signals by photo-electro conversion, and the signals are reproduced as a visible image on a recording material such as a silver halide photographic material or a CRT.

Such the reproduction method of radiation method has an advantage that a radiation image rich in information amount can be obtained by considerably small amount of exposing radiation compared with that necessary for the combination of a photographic material for radiation recording and an intensifying screen.

The phosphor is a phosphor capable of emitting stimulation emission light by irradiation by the stimulation light after irradiation by the radiation; a phosphor emitting light having a wavelength of 300 to 500 nm by the stimulating light having a wavelength of 400 to 900 nm is usually employed in the practical use.

The radiation image conversion panel employing such the phosphor releases the accumulated energy by the scanning by the stimulating light, therefore, the panel can accumulate again a radiation image after the scanning so as to be used repeatedly. Namely, the radiation image conversion method is also advantageous from the viewpoint of resources saving and economical efficiency since the radiation image conversion panel is repeatedly used in this method compared with the usual radiation photographic method in which the radiation photographic film is consumed for every one image taking.

It is preferable that the stimulation light for scanning is difficultly scattered in the phosphor layer. For making such the situation, it is required to raise the density of the phosphor and to reduce the distance between the particles. When the phosphor particles are layered together with a large amount of a binder, the distances between the particles are enlarged and the degradation of the sharpness caused by the light scattering cannot be avoided.

As countermeasures to the above problems, a method for forming a layer having phosphor light emitting function by plasma spraying phosphor powder onto a substrate surface, cf. Patent Document 4, and a method for forming the stimulable phosphor layer by a flame spraying method and a gas phase sedimentation method, cf. Patent Document 5, are proposed. However, the shape and the particle diameter distribution of the phosphor formed on the substrate are difficultly controlled and the sharpness is difficultly raised since the phosphor is supplied in the melted state in the both methods.
Patent Document 1: JP-A No. 58-13666
Patent Document 2: JP-A No. 1-128144
Patent Document 3: JP-A No. 9-314032
Patent Document 4: JP-A No. 63-169370
Patent Document 5: JP-A No. 1-131500

### SUMMARY OF THE INVENTION

An object of the invention is to provide a method for forming a uniform composite layer containing inorganic particles holing the properties thereof and a particle including the inorganic particle to be used in the method, which can flame sprayed, and to provide the composite layer containing a phosphor having high luminance and sharpness by using the phosphor as the inorganic material and a radiation image conversion panel using the composite layer.

From one aspect, a composite layer comprising inorganic particles and a thermoplastic resin is formed by this invention, the method comprises a step of
flame spraying a mixture or the inorganic particles and the thermoplastic resin particles to a substrate, wherein each of the inorganic particles and the thermoplastic resin particles has a temperature of not less than the glass transition point of the thermoplastic resin and not more than the melting point of the inorganic particles, and
the mixture comprises from 85 to 99% by weight of the inorganic particles and from 15 to 1% by weight of thermoplastic resin particles, total weight of the mixture being 100% by weight.

The other aspect is a method for forming a composite layer comprising inorganic particles and a thermoplastic resin by flame spraying composite particles each of particles comprises the inorganic particles and a thermoplastic resin.

A method for forming a uniform composite layer containing inorganic particles without degradation of propertied thereof and a thermoplastic resin can be provided by the invention. A radiation image conversion phosphor layer having high sharpness and high luminance and a radiation image conversion panel employing the layer can be provided by employing a phosphor as the inorganic particles.

The invention is described in detail below.

The inventors have investigated the method for producing the composite layer containing the inorganic particles and the thermoplastic resin. The composite layer is formed by spraying the mixture having a content of the inorganic particles of from 85% to 99% by weight and a content of the thermoplastic particles of from 1.0% to 15% by weight while controlling the temperature of a mixture of the inorganic particles and the thermoplastic particles so that the temperature is not less than the Tg of the thermoplastic resin at which the thermoplastic resin is melted or partially melted and not more than the melting point of the inorganic particle at which the inorganic particle is not melted or not partially melted. The thermoplastic resin is preferably contained in the mixture in a state of particles.

From another viewpoint, the composite layer can be formed by flame spraying composite particles each comprising the thermoplastic resin and the inorganic particles. It is preferable that the inorganic particles are previously subjected to a surface treatment by a silane coupling agent.

The high luminance and the sharpness can be attained by the composite layer forming method according to the invention since the inorganic particles are sprayed at a temperature at which the inorganic particles are not melted or not partially molted while holding the shape and the distribution together with extremely small amount of the thermoplastic resin so as to form the layer uniformly having the properties, because the inorganic particles prepared by exactly controlling are not subjected to a re-melting process which is applied in the plasma spraying method and the gas sedimentation method such as PVD and CVD.

Hereinafter, the method by flame spraying the mixture is referred to as “a mixture flame spraying method”. The mixture employed in the mixture flame spraying method has a content of inorganic particles of from 85% to 99% by weight and a content of the thermoplastic resin particle of from 1.0 to 15% by weight, the total mount of the mixture being 100% by weight. The composite layer can be formed by such the composition, which has the sufficient strength and uniformly contains the inorganic particles in high density so that the spreading of scattered light is small.

Various kinds of thermoplastic resin can be employed. For example, a polyethylene resin, polypropylene resin, nylon-11 resin, nylon 12 resin, ethylene-vinyl acetate copolymer resin, ethylene-acrylic acid copolymer resin, ethylene-methacrylic acid copolymer resin, modified polyethylene resin and modified polypropylene resin are employable. These resins may be used in an optional combination.

The diameter of the thermoplastic resin particle to be used for the flame spraying is from 0.1 to 500 μm and more preferably from 1 to 100 μm. The diameter and the amount of the thermoplastic resin particles are selected according to the using object of the composite layer considering the amount and the particle diameter of the inorganic material.

From another viewpoint, the method of the invention is a method for forming the composite layer by flame spraying composite particles composed of the thermoplastic resin and the inorganic particles.

The inorganic particles are different from the thermoplastic resin in the specific gravity and the surface area; therefore, the spraying rates of them are different from each other so that the formation of the composite layer uniformly comprising the inorganic articles and the thermoplastic resin is difficult a little when the mixture of them is sprayed in untouched state.

The unevenness of the layer composition caused by the difference of the spraying rate can be inhibited by flame spraying the composite particles containing the previously prepared inorganic particles and the thermoplastic resin. Such the method is advantageous since the method is easily controlled for giving a slant in the content of the inorganic particles in the layer composition. In the usual flame spraying, the diameter of the inorganic particle is necessary to be several micrometers or more; the particle diameter can be made larger by forming the composite particle containing plural particles when the particle diameter is submicron class. Consequently, the flame spraying can be stably performed without any variation in the diameter of primary particles.

Namely, the inorganic particle having a diameter of submicron class can be contained in the composite layer without any variation in the diameter by flame spraying under a condition in which the thermoplastic is only melted and the inorganic particles is not melted so that the necessary properties of the inorganic particle can be maintained. When the inorganic particles melted at high temperature are sprayed, the inorganic particles are combined with other particles or the chemical or physical property of the surface is varied, accordingly the properties of the original particles are difficultly maintained.

The composing state of the inorganic particles and the thermoplastic can take various forms such as one having a core/shell structure in which the core of the inorganic particle included by the shell of the thermoplastic resin, one having a reverse structure of the above and one having a plural dimensional state in which plural composite particles adhering with each other. Among them, the core/shell particle is preferable, in which a part (preferably not less than 50%, and more not less than 80%, in area ratio) or the entire surface of the inorganic particle is covered with the thermoplastic resin. The ratio of the inorganic particles is preferably from 85 to 99% by weight of the core/shell type particle.

Examples of the preparation method of the composite particle composed of the thermoplastic resin and the inorganic particles according to the invention are described below.

Various methods such as those described below can be optionally selected according to the situation of the flame spraying:
(1) A method in which a monomer as the raw material of the thermoplastic resin is dropped into a suspension of the inorganic particles for performing interface polymerization.
(2) A method in which the inorganic particles are dispersed in a solution of the thermoplastic resin and then the solubility of the resin is lowered or the solvent of the thermoplastic resin is evaporated so as to be deposited the thermoplastic resin on the surface of the inorganic particles.
(3) A method in which the inorganic particles are deposited on the thermoplastic resin particles by a sol-gel method.

For the thermoplastic resin for preparing the composite particle, the thermoplastic resin usable for the flame spraying can be employed.

The inorganic particles are preferably treated by a silane coupling agent before the flame spraying or the preparation of the composite particles.

The treatment of the inorganic particle surface by the silane coupling agent is effective to raise the affinity of the inorganic particle with the thermoplastic resin so as to form the composite layer higher in the strength. Sufficient strength of the composite layer can be obtained even when the content of the thermoplastic resin is extremely lowered to a content of from 1.0 to 1.5% by weight.

Silane coupling agents usable in this invention are not specifically limited but compounds represented by the following formula (1) are preferred: 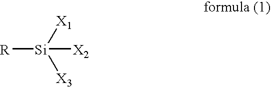
wherein R is an aliphatic or aromatic hydrocarbon group, which may be intervened with an unsaturated group (e.g., vinyl) or may be substituted by R₂OR₃—, R₂COOR₃—, R₂NHR₃— (in which R₂ is an alkyl group or an aryl group, and R₃ is an alkylene group or an arylene group) or other substituents; X₁, X₂ and X₃ are each an aliphatic or aromatic hydrocarbon group, acyl group, amido group, alkoxy group, alkylcarbonyloxy group, epoxy group, mercapto group or a halogen atom, provided that at least one of X₁, X₂ and X₃ is a group other than the hydrocarbon group. X₁, X₂ and X₃ are preferably a group subject to hydrolysis.

Specific examples of the silane coupling agent of formula (I) include methyltrimethoxysilane, methyltriethoxysilane, vinyltriacetoxysilane, vinyltrichlorosilane, vinyltriethoxysilane, γ-chloropropyltrimethoxysilane, γ-chloropropylmethyldichlorosilane, γ-chloropropyl-methyldimethoxysilane, γ-chloropropylmethyldiethoxysilane, γ-aminopropyltriethoxysilane, N-(β-aminoethyl)-γ-aminopropyl-trimethoxysilane, N-(β-aminoethyl)-γ-aminopropylmethyl-dimethoxysilane, γ-mercaptopropyltrimethoxysilane, γ-mercaptopropylmethyldimethoxysilane, γ-glycidoxypropyl-trimethoxysilane, γ-methacryloxypropyltrimethoxysilane, γ-methacryloxypropylmethyldimethoxysilane, γ-(2-amonoethyl)-aminopropyltrimethoxysilane, γ-isocyanatepropyltriethoxy-silane, γ-(2-aminoethyl)aminopropylmethyldimethoxysilane, γ-anilinopropyltrimethoxysilane, vinyltrimethoxysilane, and N-β-(N-vinylbenzylaminoethyl)-γ-aminopropyltrimethoxy-silane.hydrochloric acid salt or aminoslane composite. Of these, vinyl type, mercapto type, glycidoxy type and methacryloxy type are preferred. In the embodiments of this invention, the silane coupling agent preferably contains a mercapto group, such as γ-mercaptopropyltrimethoxysilane and γ-mercaptopropylmethyldimethoxysilane.

The methods for providing the treatment onto the surface of the inorganic particles include a dry method in which the silane coupling agent is dropped or sprayed to the inorganic particles while stirring to mix the particles, a slurry method in which the silane coupling agent is dropped into the phosphor in a slurry state while stirring and then the inorganic particles are precipitated, filtered and dried to remove the remaining solvent, and a method in which the inorganic particles are dispersed in a solvent and the silane coupling agent is added to the dispersion and stirred and then the solvent is evaporated to form a adhering layer on the surface of the inorganic particles.

It is preferable for making certain the reaction between the silane coupling agent and the inorganic particles that the inorganic particles treated by the silane coupling agent are dried for a time of from 10 to 200 minutes at a temperature of from 60 to 130° C. Example of the method such the treatment is a method in which the inorganic particles are loosened in a dispersion of the inorganic particles and the silane coupling agent so that the covering by the hydrophilic fine particles and the surface treating by the silane coupling agent are simultaneously performed with the loosen of the inorganic particles and the inorganic particles are filtered and dried.

The inorganic particle is described below.

In the invention, an organic particle such as powder of an oxide, a hydroxide, a carbonate, a sulfate, a silicate, a nitride, carbon, a metal and a ceramics are preferably employable.

Examples of the oxide include silica, diatomite, alumina, zinc oxide, titanium oxide, calcium oxide, magnesium oxide, iron oxide, tin oxide, antimony oxide and ferrite. Examples of the hydroxide include calcium hydroxide, magnesium hydroxide, aluminum hydroxide and basic magnesium hydroxide. Examples of the carbonate include calcium carbonate, magnesium carbonate, zinc carbonate, dawsonite and hydrotalcite.

Examples of the sulfate include calcium sulfate, aluminum sulfate, barium sulfate and lithopone. Examples of the silicate include calcium silicate such as worastnite and xonotlite, aluminum silicate such as clay, talk, mica, mommolinite, silica sand, kaolin, powder of pumice, zeolite, bentonite, activated clay, slate powder, sepiorite, imogorite, serisite, glass fiber, gas beads, glass flake and silica balloon.

Examples of the nitride include aluminum nitride, boron nitride and silica nitride.

Examples of the carbon include carbon black, graphite, carbon fiber, activated carbon, activated carbon fiber, fullerene, carbon nanotube, carbon balloon, and charcoal powder. Other than the above-mentioned, calcium titanate, aluminum borate, titanium zirconium, molybdenum sulfide, silicon carbide and zinc borate can be cited.

The diameter of the inorganic particle can be optionally selected according to the use. A sphere-equivalent diameter of from 0.1 to 500 μm is preferred. The shape of the particle such as spherical, planar and needle-like can be also selected according to the use.

It is preferable to use various phosphors as the inorganic particle having the optical property.

Examples of the stimulable phosphor used in the radiation image conversion panel include,
(1) a rare earth activated alkaline earth metal fluorohalide phosphor represented by the formula of (Ba₁₋ₓ,M²⁺x)FX:yA, as described in JP-A No. 55-12145, in which M²⁺ is at least one of Mg, Ca, Sr, Zn and Cd; X is at least one of Cl, Br and I; A is at least one of Eu, Tb, Ce, Tm, Dy, Pr, Ho, Nd, Yb, and Er; x and y are numbers meeting the conditions of 0≦x≦0.6 and 0≦y≦0.2; and the phosphor may contain the following additives:
a) X′, BeX″ and M³X₃′″, as described in JP-A No. 56-7417.5 (in which X′, X″ and X′″ are respectively at least a halogen atom selected from the group of Cl, Br and I; and M³ is a trivalent metal);
b) a metal oxide described in JP-A No. 55-160078, such as BeO, BgO, CaO, SrO, BaO, ZnO, Al₂O₃, Y₂O₃, La₂O₃, In₂O₃, SiO₂, TiO₂, ZrO₂, GeO₂, SnO₂, Nb₂O₅ or ThO₂;
c) Zr and Sc described in JP-A No. 56-116777;
d) B described in JP-A No. 57-23673;
e) As and Si described in JP-A No. 57-23675;
f) M.L (in which M is an alkali metal selected from the group of Li, Na, K, Rb and Cs; L is a trivalent metal Sc, Y, La, Ce, Pr, Nd, Pm, Sm, Gd, Tb, Dy, Ho, Er, Tm, Yb, Lu, Al, Ga, In, and Tl) described in JP-A 58-206678;
g) calcined tetrafluoroboric acid compound described in JP-A No. 59-27980;
calcined, univalent or divalent metal salt of hexafluorosilic acid, hexafluorotitanic acid or hexafluorozirconic acid described in JP-A No. 59-27289;
NaX′ described in JP-A No. 59-56479 (in which X′ is at least one of Cl, Br and I);
h) a transition metal such as V, Cr, Mn, Fe, Co or Ni, as described in JP-A No. 59-56479;
M¹X′, M′²X″, M³X′″ and A, as described in JP-A No. 59-75200 (in which M¹ is an alkali metal selected from the group of Li, Na, K, Rb and Cs; M′² is a divalent metal selected from the group of Be and Mg; M³ is a trivalent metal selected from the group Al, Ga, In and Tl; A is a metal oxide; X′, X″ and X′″ are respectively a halogen atom selected from the group of F, Cl, Br and I);
i) M¹X′ described in JP-A No. 60-101173 (in which M¹ is an alkali metal selected from the group of Rb and Cs; and X′ is a halogen atom selected from the group of F, Cl, Br and I);
j) M²′X′₂.M²′X″₂ (in which M²′ is at least an alkaline earth metal selected from the group Ba, Sr and Ca; X′ and X″ are respectively a halogen atom selected from the group of Cl, Br and I, and X′ is not X″); and
   LnX″₃ described in JP-A No. 61-264084 (in which Ln is a rare earth selected from the group of Sc, Y, La, Ce, Pr, Nd, Pm, Sm, Gd, Tb, Dy, Ho, Er, Tm, Yb and Lu; X″ is a halogen atom selected from the group of F, Cl, Br and I);
   (2) a divalent europium activated alkaline earth metal halide phosphor described in JP-A No. 60-84381, represented by the formula of M²X₂.aM²′₂:xEu²⁺ (in which M² is an alkaline earth metal selected from the group of Ba, Sr and Ca; X and X′ is a halogen atom selected from the group of Cl, Br and I and X≠X′; a and x are respectively numbers meeting the requirements of 0≦a≦0.1 and 0≦x≦0.2);
   the phosphor may contain the following additives;
a) M¹X″ described in JP-A No. 60-166379 (in which M¹ is an alkali metal selected from the group of Rb, and Cs; X″ is a halogen atom selected from the group of F, Cl, Br and I;
b) KX″, MgX₂′″ and M³X₃″″ described in JP-A No. 221483 (in which M³ is a trivalent metal selected from the group of Sc, Y, La, Gd and Lu; X″, X′″ and X″″ are respectively a halogen atom selected from the group of F, Cl Br and I;
c) B described in JP-A No. 60-228592;
   an oxide such as SiO₂ or P₂O₅ described in JP-A No. 60-228593;
   LiX″ and NaX″ (in which X″ is a halogen atom selected from the group of F, Cl, Br and I;
d) SiO₂ described in JP-A No. 61-120883;
   SnX₂″ described in JP-A 61-120885 (in which X″ is a halogen atom selected from the group of F, Cl, Br and I;
e) CsX″ and SnX₂′″ described in JP-A No. 61-235486 (in which X″ and X′″ are respectively a halogen atom selected from the group of F, Cl, Br and I;
   CsX″ and Ln³⁺ described in JP-A 61-235487 (in which X″ is a halogen atom selected from the group of F, Cl, Br and I; Ln is a rare earth element selected from the group of Sc, Y, Ce, Pr, Nd, Sm, Gd, Tb, Dy, Ho, Er, Tm, Yb and Lu;
   (3) a rare earth element activated rare earth oxyhalide phosphor represented by the formula of LnOX:xA, as described in JP-A No. 55-12144 (in which Ln is at least one of La, Y, Gd and Lu; A is at least one of Ce and Tb; and x is a number meeting the following condition, 0<x<0.1);
   (4) a cerium activated trivalent metal oxyhalide phosphor represented by the formula of M(II)OX:xCe, as described in JP-A No. 58-69281 (in which M(II) is an oxidized metal selected from the group of Pr, Nd, Pm, Sm, Eu, Tb, Dy, Ho, Er, Tm, Yb and Bi; X is a halogen atom selected from the group of Cl, Br and I; x is a number meeting the following condition, 0<x<0.1;
   (5) a bismuth activated alkali metal halide phosphor represented by the formula of M(I)X:xBi, as described in JP-A No. 62-25189 (in which M(I) is an alkali metal selected from the group of Rb and Cs; X is a halogen atom selected from the group of Cl, Br and I; x is a number meeting the following condition, 0<x≦0.2;
   (6) a divalent europium activated alkaline earth metal halophosphate phosphor represented by the formula of M(II)₅(PO₄)₃X:xEu²⁺, as described in JP-A No. 60-141783 (in which M(II) is an alkaline earth metal selected from the group of Ca, Sr and Ba; X is a halogen atom selected from the group of F, Cl, Br and I; x is a number meeting the following condition, 0<x≦0.2);
   (7) a divalent europium activated alkaline earth metal haloborate phosphor represented by the formula of M(II)₂BO₃X:xEu², as described in JP-A No. 60 157099 (in which M(II) is an alkaline earth metal selected from the group of Ca, Sr and Ba; X is a halogen atom selected from the group of Cl, Br and I; x is a number meeting the following condition, 0<x≦0.2);
   (8) a divalent europium activated alkaline earth metal halophosphate phosphor represented by the formula of M(II)₂PO₄X:xEu²⁺, as described in JP-A No. 60-157100 (in which M(II) is an alkaline earth metal selected from the group of Ca, Sr and Ba; X is a halogen atom selected from the group of Cl, Br and I; x is a number meeting the following condition, 0<x≦0.2);
   (9) a divalent europium activated alkaline earth metal hydrogenated halide phosphor represented by the formula of M(II)HX:xEu²⁺, as described in JP-A No. 60-217354 (in which M(II) is an alkaline earth metal selected from the group of Ca, Sr and Ba; X is a halogen atom selected from the group of Cl, Br and I; x is a number meeting the following condition, 0<x≦0.2);
   (10) a cerium activated rare earth complex halide phosphor represented by the formula of LnX₃.aLn′X₃′:xCe³⁺, as described in JP-A No. 61-21173 (in which Ln and Ln′ are individually a rare earth element selected from the group of Y, La, Gd and Lu; X and X′ are respectively a halogen atom selected from the group of F, Cl, Br and I and X+X′; a and x are respectively numbers-meeting the following conditions, 0.1<a≦10.0 and 0<x≦0.2;
   (11) a cerium activated rare earth complex halide phosphor represented by the formula of LnX₃.aM(I)X′:xCe³⁺, as described in JP-A 61-21182 (in which Ln and Ln′ are respectively a rare earth element selected from the group of Y, La, Gd and Lu; M(I) is an alkali metal selected from the group of Li, Na, k, Cs and Rb; X and X′ are respectively a halogen atom selected from the group of Cl, Br and I; a and x are respectively numbers meeting the following conditions, 0.1<a≦10.0 and 0<x≦0.2;
   (12) a cerium activated rare earth halophosphate phosphor represented by the formula of LnPO₄.aLnX₃:xCe³⁺, as described in JP-A No. 61-40390 (in which Ln is a rare earth element selected from the group of Y, La, Gd and Lu; X is a halogen atom selected from the group of F, Cl, Br and I; a and x are respectively numbers meeting the following conditions, 00.1<a≦10.0 and 0<x≦0.2;
   (13) a divalent europium activated cesium rubidium halide phosphor represented by the formula of CsX:aRbX′:xEu²⁺, as described in JP-A No. 61-236888 (in which X and X′ are individually a halogen atom selected from the group of Cl, Br and I; a and x are respectively numbers meeting the following conditions, 0.1<a≦10.0 and 0<x≦0.2;
   (14) a divalent europium activated complex halide phosphor represented by the formula of M(II)X₂.aM(I)X′:xEu²⁺, as described in JP-A No. 61-236890 (in which M(II) is an alkaline earth metal selected from the group of Ba, Sr and Ca; M(I) is an alkali metal selected from the group of Li, Rb and Cs; X and X′ are respectively a halogen atom selected from the group of Cl, Br and I; a and x are respectively numbers meeting the following conditions, 0.1<a≦20.0 and 0<x≦0.2.

Among the above-mentioned stimulable phosphors, stimulable phosphor particles each containing iodine are preferable. A di-valent europium-activated alkali-earth metal fluoride halide type iodine-containing phosphor, a di-valent europium-activated alkali-earth metal halide type iodine-containing phosphor, a rare earth element-activated rare element oxohalide type iodine-containing phosphor and a bismuth-activated alkali halide type iodine-containing phosphor are preferable since they emit stimulation light with high luminance, and an Eu-added BaFI compound is preferred as the stimulable phosphor. The particle size of the stimulable phosphor is preferably from 1 to 50 μm.

In the production method of the composite layer, the layer is formed by flame spraying the mixture of the inorganic particles and the thermoplastic resin particles or the composite particles while controlling the temperature at a level at which the thermoplastic resin is melted or partially melted and the inorganic particle is not partially or entirely melted. Practically, a temperature not less than the glass transition point of the thermal resin and not more than the melting point of the inorganic particle.

Though various methods such as a plasma spraying method, a pressure reducing flame spraying method, a high velocity flame spraying method (HVOF), an electric arc spraying method and a gas flame spraying method are applicable for the production method of the composite layer, and the gas flame spraying method is preferred since by which spraying at a low temperature can be easily performed for preventing the oxidation or burning of the thermoplastic resin used in the spraying.

In the gas flame spraying method, the materials are sprayed by gas flame which is controlled at a flame temperature of from 200 to 1200° C. and a flame velocity of from 80 to 200 m/second using, for example, propane gas, propylene gas, butane gas, hydrogen gas or kerosene as the main burning gas and oxygen or air as the burning aid. It is preferable that the surface of the substrate to be sprayed is roughen to a center line surface roughness of from 1 to 15 μm and previously heated at a temperature of from 70 to 250° C., and then the spraying is performed.

As the substrate, for example, various kinds of polymer material, glass and metal are employed. The shape of the substrate may be planar, complexly irregular or curved.

On thus formed composite layer, a protective film may be provided. For the protective film, for example, a polyester film, polymethacrylate film, nitrocellulose film and cellulose acetate film are employable, and an elongated film of poly(ethylene terephthalate) or poly(ethylene naphthalate) is preferred for the protective layer from the viewpoint of the transparency and the strength. Moreover, the poly(ethylene terephthalate) film or the poly(ethylene naphthalate film) on which a thin layer of a metal oxide or silicon nitride is vapor deposited is also preferred.

The thickness of said stimulable phosphor layer varies depending on the target characteristics of the radiation image conversion panel, the types of stimulable phosphors, and the mixing ratio of binders to stimulable phosphors. However, said thickness is preferably in the range of 10 to 1,000 μm, and is more preferably in the range of 10 to 500 μm.

The radiation image conversion panel according to the present invention is described.

A phosphor sheet, prepared by applying the stimulable phosphor layer onto a support, is then cut into specified sizes.

Any of several common methods may be employed for cutting. However, from the viewpoint of workability as well as accuracy, trimming machines or punching machines are preferred. The radiation image conversion panel of the present invention is preferably provided with a protective layer (hereinafter occasionally referred to as a protective film) in order to chemically and physically protect the surface of the stimulable phosphor layer. Said protective layer may be suitably constituted based on its purposes as well as its use.

Examples of protective layers to cover said stimulable phosphor layer may be polyester film, polymethacrylate film, nitrocellulose film, and cellulose acetate film, provided with a stimulating light absorbing layer at a haze ratio of 5 to 60 percent, determined by the method described in ASTMD-1003. Of these, from the viewpoint of transparency as well as strength, stretched films such as polyethylene terephthalate film and polyethylene naphthalate film are preferred, and from the aspect of moisture resistance, metallized films are specifically preferred, which are obtained by applying a thin layer comprised of metal oxides or silicone nitride onto said polyethylene terephthalate film or polyethylene naphthalate film through vacuum evaporation.

The haze ratio to obtain the effects of the present invention is preferably from 5 to 60 percent, and is more preferably from 10 to 50 percent. A haze ratio of less than 5 percent is not preferred, since effects to minimize image unevenness, as well as to minimize linear noise, decrease. On the other hand, said haze ratio of more than or equal to 0.60 percent is also not preferred, since sharpness enhancing effects are degraded.

In order to satisfy required moisture resistance, optimal moisture resistance is obtained by laminating a plurality of resinous films and metallized films obtained by vacuum-evaporating metal oxides onto said resinous film. In order to minimize degradation of stimulable phosphors due to moisture absorption, it is preferable to achieve no more than 50 g/m²·day. The method of laminating a resinous film is not specially limited and known conventional methods can be applied.

Further, an excitation light absorbing layer is preferably provided between the laminated resinous films so that said excitation light absorbing layer is protected from physical impact as well as chemical modification so as to stabilize the plate functions over an extended period of time. In addition, said excitation light absorbing layer may be provided in a plurality of positions, and an adhesive layer for lamination may be comprised of coloring agents, thereby being utilized as the excitation light absorbing layer.

A protective film may be provided a adhesion layer between a stimulable phosphor layer. However, a structure which covers all of the stimulable phosphor surface is preferred. This structure is called a “sealed structure”. When a phosphor plate is sealed employing a protective film, it is possible to employ any of the several conventionally known methods such as a phosphor sheet which is interposed between moisture resistant protective films and the peripheral edge of which is subjected to lamination under application of heat and pressure employing an impulse sealer, and lamination is carried out between rollers under application of heat and pressure. By employing a heat fusible resinous film as the resinous layer of the outermost layer in contact with the phosphor sheet of the moisture resistant protective film, the moisture resistant protective film is fused, whereby the efficiency of sealing work of the phosphor sheets is enhanced. The moisture resistant protective film is preferably provided on both sides of the phosphor sheet and the peripheral edge of said moisture resistant protective films, which is located beyond the peripheral edge of said phosphor sheet, is fused to result in a sealed structure, whereby it is possible to prevent infusion of water from the outside. Further, the moisture resistant protective film on one side of the support may be laminated with at least one aluminum film. By employing such a support, it is possible to assure minimal water infusion.

Further, said heat fusion, which is carried out employing an impulse sealer, is preferably performed under reduced pressure to minimize the displacement of the phosphor sheet in the moisture resistant protective film and to remove moisture from the atmosphere.

Still further, the phosphor surface may or may not be allowed to come into contact with the heat fusible resinous layer of the outermost layer on the side in contact with the phosphor surface of the moisture resistant protective film. The non-contact state, as described herein, refers to the state in which the phosphor surface and the moisture resistant protective film are optically and mechanically handled mostly as discontinuous body, even though they may come into “point” contact. Further, the heat fusible film, as described herein, refers to the resinous films which are fusible in the generally used impulse sealer, and include, for example, ethylene-vinyl acetate copolymers (EVA), polypropylene (PP) film, and polyethylene (PE) film. However, the present invention is not limited to these examples.

### EXAMPLES

The invention is described below referring examples.

Preparation of Phosphor Sheet

### Preparation of Phosphor Sheet 1: Mixture Flame Spraying Method, Inventive Example

(Preparation of Phosphor A)

For synthesizing a phosphor precursor of a europium-activated barium fluoroiodide, 2780 ml of an aqueous solution of BaI₂ (3.6 moles/liter) and 27 ml of an aqueous solution of EuI₃ (0.15 moles/liter) were put into a reaction vessel and held at 83° C. while stirring. After that, 322 ml of an aqueous solution of ammonium fluoride (8 moles/liter) was added through a roller pump into the reaction mother liquid to prepare precipitation. The temperature keeping and the stirring were continued for 2 hours after the addition for ripening the precipitation.

The precipitation was filtered, washed by methanol and dried in vacuum, thus crystals of europium-activated barium fluoroiodide were obtained. For preventing the variation in the particle shape and the particle size distribution caused by sintering on the occasion of baking, 0.2% by weight of an extremely fine powder of alumina was added and sufficiently stirred by a mixer so as to uniformly adhere the alumina fine-particles onto the crystal surface. The crystals were filled in a quartz boat and baked for 2 hours at 850° C. in hydrogen atmosphere using a tube furnace and crushed in a mortar and then classified to prepare Phosphor A having an average particle diameter of 9 μm.

(Formation of Composite Layer)

A raw material powder to be flame sprayed was prepared by mixing 10% by weight of nylon powder having a melting point of 180° C. and a particle diameter of 30 to 200 μm as the thermoplastic resin and 90% by weight of the above prepared Phosphor. A as the inorganic particles. An aluminum plate having a thickness of 0.1 mm was employed as the substrate to be sprayed; the plate was subjected to a blast treatment by blasting alumina grit (granule degree of #20) at a pressure of 0.5 MPa, and to preliminary heating treatment by heating by 170° C.

The raw material powder containing the phosphor was flame sprayed by the low temperature flame spraying method on to the aluminum plate under the following conditions.

(Spraying Condition)
Burning gas: Oxygen gas (pressure: 350 kPa), propane gas (pressure: 350 kPa) and air (pressure: 560 kPa)
Flame temperature: 900° C.
Flame velocity: 150 m/second
Spraying distance: 350 mm
Supplying amount of raw material powder: 50 g/second

The above flame temperature was a temperature at which the nylon powder as the thermoplastic resin was melted or partially melted and the Phosphor A was not molted or not partially molted.

The thickness of the layer of thus obtained Phosphor Sheet 1 was 210 μm.

### Preparation of Phosphor Sheet 2: Mixture Flame Spraying Method, Comparative Example)

Phosphor Sheet 2 was prepared in the same manner as in Phosphor Sheet 1 except that the content of the nylon powder as the thermoplastic resin and that of the Phosphor A were each varied to 40% and 60% by weight, respectively, and the thickness of the layer was varied to 310 μm.

### Preparation of Phosphor Sheet 3: Mixture Flame Spraying Method, Comparative Example

Phosphor Sheet 3 was prepared in the same manner as in Phosphor Sheet 1 except that the spraying conditions were changed as follows.
(Flame spraying condition)
Burning gas: Oxygen gas (pressure: 1.2 MPa), hydrogen gas (pressure: 1 MPa) and air (pressure: 700 kPa)
Flame temperature: 2700° C.
Flame velocity: 2100 m/second
Spraying distance: 225 mm
Supplying amount of raw material powder: 80 g/second

At the above temperature, both of the nylon powder as the thermoplastic resin and Phosphor A were melted or partially melted.

### Preparation of Phosphor Sheet 4: Mixture Flame Spraying Method, Inventive Example

(Preparation of Phosphor B)

A europium-activated barium fluorobromide phosphor BaFBr: 0.001Eu²⁺ was prepared according to the following procedure.

Into a reaction vessel, 1780 ml of an aqueous solution (4.5 moles/liter) of NH₄Br, 5 ml of an aqueous solution (0.2 moles/liter) of EuBr₃ and 215 ml of water were charged. The reaction liquid in the reaction vessel having a concentration of NH₄Br 4.0 moles/liter was kept at 60° C., and then 100 ml of an aqueous solution (10 moles/liter) of NH₄F and 400 ml of an aqueous solution (2.5 moles/liter) of BaBr₂ were separately added to a mixing room in the reacting liquid using precise cylinder pumps while stirring and keeping the temperature so that the mole ratio of NH₄F and BaBr₂ is held at constant.

Thus formed precipitation of precursor crystals were filtered and washed by 2 liter of methanol. The washed precursor crystals were putout and dried under vacuum for 4 hours at 120° C., thus 220 g of europium-activated barium fluorobromide crystals were obtained. For preventing the variation of the particle shape and the particle size distribution caused by sintering on the occasion of baking, 0.2% by weight of an extremely fine powder of alumina was added and sufficiently stirred by a mixer so as to uniformly adhere the alumina fine particles onto the crystal surface. One hundred grams of the crystals were filled in a quartz boat and baked for 2 hours at 850° C. in nitrogen atmosphere using a tube furnace to prepare Phosphor B of europium-activated barium fluorobromide (BaFBr:0.001Eu²⁺). The average particle diameter of the phosphor was 9 μm.

(Flame Spraying Conditions)

A phosphor layer was formed under the same flame spraying conditions as in Phosphor Sheet 1 except that the Phosphor B is employed in place of the Phosphor A to prepare Phosphor Sheet 4.

### Preparation of Phosphor Sheet 5: Mixture Flame Spraying Method, Comparative Example

Phosphor Sheet 5 was prepared in the same manner as in Phosphor Sheet 4 except that the flame spraying conditions were changed to the followings.

(Flame Spraying Condition)
Burning gas: Oxygen gas (pressure: 1.2 MPa), hydrogen gas (pressure: 1 MPa) and air (pressure: 700 kPa)
Flame temperature: 2700° C.
Flame velocity: 2100 m/second
Spraying distance: 225 mm
Supplying amount of raw material powder: 80 g/second

At the above temperature, both of the nylon powder as the thermoplastic resin and Phosphor A were melted or partially melted.

### Preparation of Phosphor Sheet 6: Flame Spraying Method Using Composite Particles, Inventive Example

In 500 parts of methyl ethyl ketone dissolving therein 10 parts of BL-S (poly(vinyl butyral) manufactured by Sekisui Chemical Co., Ltd.), 90 parts of Phosphor A used in the preparation of Phosphor Sheet 1 was dispersed and granulated by drying by a spray dryer (FL-12, manufactured by Ohkawara Kakohki Co., Ltd.) at a drying temperature of 100° C. in nitrogen atmosphere for reducing the methyl ethyl ketone content in the product by less than 1% by weight to composite particles composed of the phosphor particles and the thermoplastic resin. The average diameter of the composite particles was 11 μm in volume-equivalent particle diameter.

(Flame Spraying Conditions)

Phosphor Sheet 6 was prepared in the same manner as in Phosphor Sheet 1 except that nylon resin as the thermoplastic resin was not employed.

### Preparation of Phosphor Sheet 7: Flame Spraying Method Using Composite Particles, Comparative Example

Phosphor Sheet 7 was prepared in the same manner as in Phosphor Sheet 6 except that the flame spraying conditions were changed to the followings.

(Flame Spraying Condition)
Burning gas: Oxygen gas (pressure: 1.2 MPa), hydrogen gas (pressure: 1 MPa) and air (pressure: 700 kPa)
Flame temperature: 2700° C.
Flame velocity: 2100 m/second
Spraying distance: 225 mm
Supplying amount of raw material powder: 80 g/second

At the above temperature, both of the poly(vinyl butyral) resin as the thermoplastic resin and Phosphor A were melted or partially melted.

### Preparation of Florescent Sheet 8: Mixture Flame Spraying Method, Inventive Example

(Preparation of Phosphor A2)

In a methanol dispersion containing the following compounds, 100 g of Phosphor A used in the preparation of Phosphor Sheet 1 was immersed to prepare slurry. The slurry was filtered, crushed in a mortar and dried at 80° C. for 3 hours and classified to prepare Phosphor A2 having an average particle diameter of 10 μm. Phosphor Sheet 8 was prepared by forming a phosphor layer under the same conditions as in Phosphor Sheet 1.
Silane coupling agent (γ-mercaptopropyltrimethoxysilane) 5.0 g
Hydrophilic fine particle (Silica Particle manufactured by Nihon Aerosil Co., Ltd., average particle diameter: 12 nm) 0.5 g
Phosphor sheet 8 was prepared by forming a phosphor layer in the same flame spraying conditions as in Phosphor Sheet 1.

### Preparation Phosphor Sheet 9: Mixture Flame Spraying Method, Comparative Example

Phosphor Sheet 9 was prepared in the same manner as in Phosphor Sheet 8 except that the flame spraying conditions were changed as follows.

(Flame Spraying Condition)

Burning gas: Oxygen gas (pressure: 1.2 MPa), hydrogen gas (pressure: 1 MPa) and air (pressure: 700 kPa)
Flame temperature: 2700° C.
Flame velocity: 2100 m/second
Spraying distance: 225 mm
Supplying amount of raw material powder: 80 g/second

At the above temperature, both of the nylon powder as the thermoplastic resin and Phosphor A2 were melted or partially melted.

(Observation of the Surface of the Phosphor Sheet)

The surface of each of the above-prepared phosphor sheets was visually observed to examine the color thereof. Results of the observation are listed in Table 1.

Preparation of Moisture-Proof Protective Film

A protective film having the following constitution A to be provided onto the phosphor layer side of each of the above-prepared phosphor sheets was prepared.

Constitution A
NY15///VMPET12///VMPET12///PET12///CPP20
NY: Nylon
PET: Poly(ethylene terephthalate)
CPP: Casting polypropylene
   MVPET: Alumina-deposited PET (manufactured by Toyo Metalizing Co., Ltd., available on the market)

The number after each of the resin film is the thickness in μm of the rein layer and “///” represents a dry lamination adhesive layer having a thickness of 3.0 μm. The adhesive used for the dry lamination was a two-liquid reactive type urethane adhesive.

A dry laminated film composed of CCP 30 μm/Aluminum film 9 μm/Poly(ethylene terephthalate) 188 μm was prepared for a protective film to be provided on the back side of the aluminum plate as the substrate of the phosphor sheet. The thickness of the adhesive layer was 1.5 μm and a two-liquid reactive type urethane adhesive was used.

Preparation of Radiation Image Conversion Panel

Radiation Image Conversion Panels 1 through 9 were prepared by cutting each of the phosphor sheets into a shape of 20 cm square and piled with the above-prepared protective films, and then the edges of the films were sealed by an impulse sealer under reduced pressure. The distance between the edge of the phosphor sheet and the sealed portion was 1 mm. The width of the heater of the impulse sealer was 3 mm.

Evaluation of the Radiation Image Conversion Panel

The luminance and the sharpness of the above-prepared radiation image conversion panels were evaluated according to the following procedure.

(Measurement of Luminance)

Each of the radiation image conversion panels was irradiated by X-rays generated by applying a valve voltage of 80 kV and stimulated by He—Ne laser light (633 nm). The intensity of the stimulation light emitted from the phosphor layer was measured by a light receiving device (a photomultiplier having spectral luminance S-5) and defined as the luminance. The luminance was represented by relative value when the luminance of Radiation Image Conversion Panel was defined as 100.

(Measurement of Sharpness)

Each of the phosphor panels was irradiated by X-rays generated by applying a valve voltage of 80 kV through a lead MFT chart, and then the panel was stimulated by the He—Ne laser light. The emitted light was received by the above-mentioned light receiving device for converting to electric signals. The electric signals was subjected to analogue/digital conversion and recorded on a hard disc. The recorded signals were analyzed by a computer to examine the modulation transfer function (MFT) of the X-ray image recorded on the hard disc. The MFT value (%) at a space frequency of 1 cycle/mm was determined. Higher MFT value is preferred since a shaper image can be obtained. It is necessary that the sharpness exceeds 65% for practical use as the radiation image conversion panel.

Results obtained by the above tests are listed in Table 1.

TABLE 1

| Radiation | | | Evaluation | | |
|---|---|---|---|---|---|
| image | | Phosphor | | Relative | |
| conversion | Phosphor | preparation | | lumines- | Sharpness |
| panel No. | sheet No. | method | Surface | cence | (%) |
| 1 | 1 | Mixture | White | 102 | 68 |
| | | flame | | | |
| | | spraying | | | |
| 2 | 2 | Mixture | White | 100 | 60 |
| | | flame | | | |
| | | spraying | | | |
| 3 | 3 | Mixture | Brown | 95 | 62 |
| | | flame | | | |
| | | spraying | | | |
| 4 | 4 | Mixture | White | 101 | 69 |
| | | flame | | | |
| | | spraying | | | |
| 5 | 5 | Mixture | Brown | 90 | 54 |
| | | flame | | | |
| | | spraying | | | |
| 6 | 6 | Mixture | White | 103 | 68 |
| | | flame | | | |
| | | spraying | | | |
| 7 | 7 | Mixture | Brown | 94 | 59 |
| | | flame | | | |
| | | spraying | | | |
| 8 | 8 | Mixture | White | 102 | 69 |
| | | flame | | | |
| | | spraying | | | |
| 9 | 9 | Mixture | Brown | 95 | 61 |
| | | flame | | | |
| | | spraying | | | |

As is cleared by the results in Table 1, the radiation image conversion panel according to the invention having the phosphor layer formed by flame spraying under the condition, in which the temperature is controlled so that the thermoplastic resin is melted or partially molted and the inorganic particles are not melted or not partially melted and the contents of the inorganic particles and the thermoplastic resin are within the condition defined in the invention, is not irregularly colored in the phosphor layer, emits high luminescent light and is excellent in the sharpness compared with the comparative examples.

1. A method for forming a composite layer comprising inorganic particles and a thermoplastic resin, which comprises a step of
flame spraying a mixture of the inorganic particles and the thermoplastic resin to a substrate at a temperature of not less than the glass transition point of the thermoplastic resin and not more than melting point of the inorganic particles,
wherein the mixture comprises 85-99% by weight of the inorganic particles and 15-1% by weight of the thermoplastic resin, total weight of the mixture being 100% by weight.

2. The method of claim 1, wherein the thermoplastic resin in the mixture is thermoplastic resin particles.

3. The method of claim 1, wherein the inorganic particles are phosphor.

4. The method of claim 1, wherein the mixture is a composite particles comprising the inorganic particles and the thermoplastic resin.

5. The method of claim 4, wherein the composite particles are core shell particles.

6. The method of claim 5, wherein each of the core shell particles has an inorganic particle core and a thermoplastic resin shell.

7. The method of claim 1, which further comprises a step, prior to flame spraying, of subjecting surface of the inorganic particles to treating with a silane coupling agent.

8. The method of claim 4, wherein the mixture is prepared by a method comprising
treating surface of the inorganic particles with a silane coupling agent, and the surface treated inorganic particles are mixed with the thermoplastic resin.

9. The method of claim 8, wherein the surface treated inorganic particles are mixed with the thermoplastic resin particles.

10. The method of claim 1, wherein the mixture of the inorganic particles and a thermoplastic resin is composite particles each of which comprises the inorganic particles and a thermoplastic resin.

11. The method of claim 10, wherein the composite particles are core shell particles comprising the inorganic particles and a thermoplastic resin.

12. The method of claim 11, wherein the core shell particles are prepared by a method comprising
treating surface of the inorganic particles with a silane coupling agent, and the surface treated inorganic particles are mixed with the thermoplastic resin.

13. The method for forming a composite layer comprising inorganic particles and a thermoplastic resin, which comprises a step of
flame spraying composite particles each which comprises the inorganic particles and the thermoplastic resin to a substrate.

14. The method of claim 13, wherein the inorganic particles are phosphor.

15. A composite layer prepared by a method of claim 1.

16. A radiation image conversion panel prepared by employing the composite layer prepared by a method of claim 3.
